(19) United States
(12) Patent Application Publication
(10) Pub. No.: US 2026/0234065 A1
(43) Pub. Date: Aug. 13, 2026

(54) ADDITIVE MANUFACTURING OF FIBER-REINFORCED COMPOSITES WITH REFRACTORY MATRIX MATERIALS

(71) Applicant: ULTRA SAFE NUCLEAR CORPORATION, Seattle, WA (US)

(72) Inventors: Kurt A. Terrani, Knoxville, TN (US); Gavin Garside, Cottonwood Heights, UT (US); Michael P. Trammell, Andersonville, TN (US); Brian Jolly, Heiskell, TN (US)

(73) Assignee: Standard Nuclear, Inc., Oak Ridge, TN (US)

(21) Appl. No.: 19/148,021

(22) PCT Filed: Jan. 19, 2024
(86) PCT No.: PCT/US2024/012142

§ 371 Date: Jul. 15, 2025

Related U.S. Application Data
(60) Provisional application No. 63/440,204, filed on Jan. 20, 2023.

(51) Int. Cl. C04B 35/80; B33Y 10/00; B33Y 70/00; C04B 35/565; C04B 41/52

(52) U.S. Cl. CPC C04B 35/80; C04B 35/565; C04B 41/524; B33Y 10/00; B33Y 70/00; C04B 2235/6026; C04B 2237/365; C04B 2237/38

(57) ABSTRACT

A method for the manufacture of fiber-reinforced three-dimensional objects using a refractory matrix material is described. The method includes the additive manufacturing of a green body from a powder-based refractory matrix material, followed by optional partial strengthening, followed by continuous fiber incorporation and reinforcement, followed by full densification via chemical vapor infiltration (CVI). The refractory matrix material can be a refractory ceramic or a refractory metal. The refractory matrix material is deposited according to a binder-jet printing process to produce a green body. The next strengthening step delivers a part ideal for handling. The part is then reinforced with continuous fiber via winding, braiding, or other method of attaching continuous fiber to the part. The composite part then undergoes a CVI step to achieve maximum density and a hermetic seal on all surfaces. Accordingly, complex refractory objects with improved mechanical integrity and toughness can be produced.

### CROSS-REFERENCE TO RELATED APPLICATIONS

This application claims priority to U.S. Provisional Patent Application No. 63/440,204, filed on Jan. 20, 2023, titled “Additive Manufacturing of Fiber-Reinforced Composites with Refractory Matrix Materials,” the entire disclosure of which is incorporated by reference herein.

### TECHNICAL FIELD

The present subject matter relates to three-dimensional (3D) printed structures for energy, propulsion, and other applications.

### BACKGROUND

Refractory materials are key enablers of advanced energy and propulsion technologies. As implied by the second law of thermodynamics and described in Carnot's ideal thermodynamic cycle; the maximum achievable temperature of a system will ultimately dictate its efficiency. This is precisely the reason for significant investments in materials development programs to design and deliver materials that can operate at higher and higher temperatures.

Significant progress has been made in development and engineering of metallic superalloys (largely nickel-based) and auxiliary solution (i.e., thermal and environmental barrier coatings) to enable the modern jet engine and combined cycle gas power plants of today. These same materials are being used or considered for other energy and propulsion applications (e.g., nuclear power, solar thermal, etc.). There exist other classes of materials, refractory materials, that offer much higher use temperatures. These include metallic refractory materials (e.g., molybdenum or tungsten) or ceramic refractory materials (e.g., silicon carbide (SiC), zirconium carbide (ZrC), graphite (C), etc.) that can operate at temperatures roughly twice that of metallic superalloys. However, in prior decades, major engineering challenges were faced in deployment of these materials that included the difficulty and expense associated with their manufacture and absence of toughness (ability to absorb plastic strain energy upon mechanical loading).

Recent technological advances have provided cost-effective methodologies for additive manufacturing of complex objects using refractory matrix materials (U.S. Pat. No. 11,285,635 B2 to Terrani, et al.). However, additional solutions are required to incorporate toughness into these components and structures, making them viable for a wider range of applications in high temperature energy generation, propulsion, and other areas.

### SUMMARY

A fabrication method 100 for the manufacture of fiber-reinforced three-dimensional object(s) 200 using a refractory matrix material for a refractory matrix 210 is described. The fabrication method 100 can include the additive manufacturing of a green body from a powder-based refractory matrix material followed by optional partial strengthening (step 101), followed by continuous fiber incorporation and reinforcement (step 102), followed by full densification (step 103) via chemical vapor infiltration (CVI). The refractory matrix material can be a refractory ceramic (e.g., silicon carbide, zirconium carbide, graphite, etc.) or a refractory metal (e.g., molybdenum, tungsten, etc.). In one example, the refractory matrix material is deposited according to a binder-jet printing process to produce a green body (step 101). The next optional partial strengthening step delivers an additively manufactured object 205 ideal for handling (step 101). The additively manufactured object 205 is then reinforced (step 102) with a continuous fiber 215 (e.g., carbon fiber or silicon carbide fiber) via winding, braiding, or other method of attaching continuous fiber 215 to the part (additively manufactured object 205). The composite part (including the additively manufactured object 205 and the continuous fiber 215) then undergoes a CVI step to achieve maximum density and a hermetic seal on all surfaces of the composite part (fiber-reinforced three-dimensional object 200) (step 103). In this manner, complex refractory objects with improved mechanical integrity and toughness can be produced.

In a first example, a fabrication method 100 includes producing a refractory part 205 (step 101), reinforcing the refractory part 205 with a fiber 215 (step 102), and integrating the refractory part 205 and the fiber 215 to produce a fiber-reinforced three-dimensional object 200 (step 103). The step 101 of producing the refractory part 205 can include: additive manufacturing, laser powder bed fusion, stereolithography, laminated object manufacturing, direct ink printing or extrusion, gel casting, or a combination thereof. The step 101 of producing the refractory part 205 can include producing the refractory part 205 as an additively manufactured object 205 formed of a refractory material. The step 102 of reinforcing the refractory part 205 with the fiber 215 can include: wrapping, winding, pulling, placing, or incorporating the continuous fiber 215 in and around the additively manufactured object 205. For example, a refractory matrix 210 and the continuous fiber 215 can be formed of silicon carbide (SiC). The step 103 of integrating the refractory part 205 and the fiber 215 can include depositing an additional refractory material 220 onto the additively manufactured object 205, into the additively manufactured object 205, or a combination thereof after reinforcing the refractory part 205 with the fiber 215.

In a second example, a fiber-reinforced three-dimensional object 200 includes: an additively manufactured object 205 that includes a refractory matrix 210 formed of a refractory material; and a continuous fiber 215 incorporated in and around the additively manufactured object 205. The continuous fiber 215 can be formed of a same type of refractory material as the refractory matrix 210. For example, the refractory matrix 210 and the continuous fiber 215 can be formed of silicon carbide (SiC) and the continuous fiber 215 can be wound around the additively manufactured object 205. The continuous fiber 215 can be wrapped as a braided fiber sleeve or a fiber sheet around the refractory matrix 210.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 is a flowchart of a fabrication method for producing a fiber-reinforced three-dimensional object shown in FIGS. 2-3.

FIG. 2 illustrates the fiber-reinforced three-dimensional object produced from the fabrication method of FIG. 1 that includes a refractory part, such as a refractory matrix, and a fiber.

FIG. 3 illustrates the fiber-reinforced three-dimensional object produced from the fabrication method of FIG. 1 that further includes additional refractory material after integration.

Parts Listing

| | |
|---|---|
| 100 | Fabrication Method |
| 200, 200A-N | Fiber-Reinforced Three-Dimensional Object |
| 205 | Refractory Part (e.g., Additively Manufactured Object) |
| 210 | Refractory Matrix |
| 215 | Fiber (e.g., Continuous Fiber) |
| 220 | Additional Refractory Material |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount.

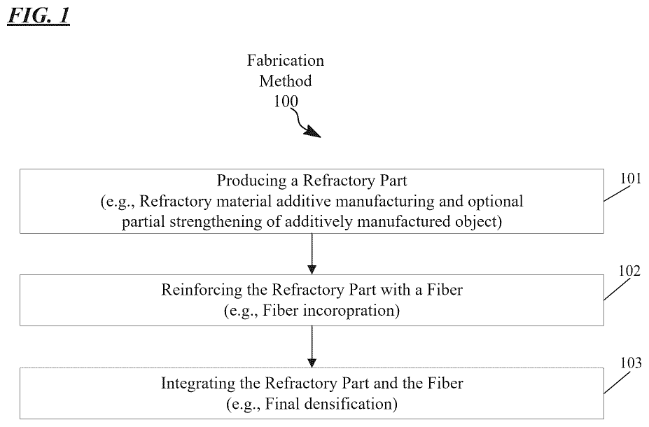

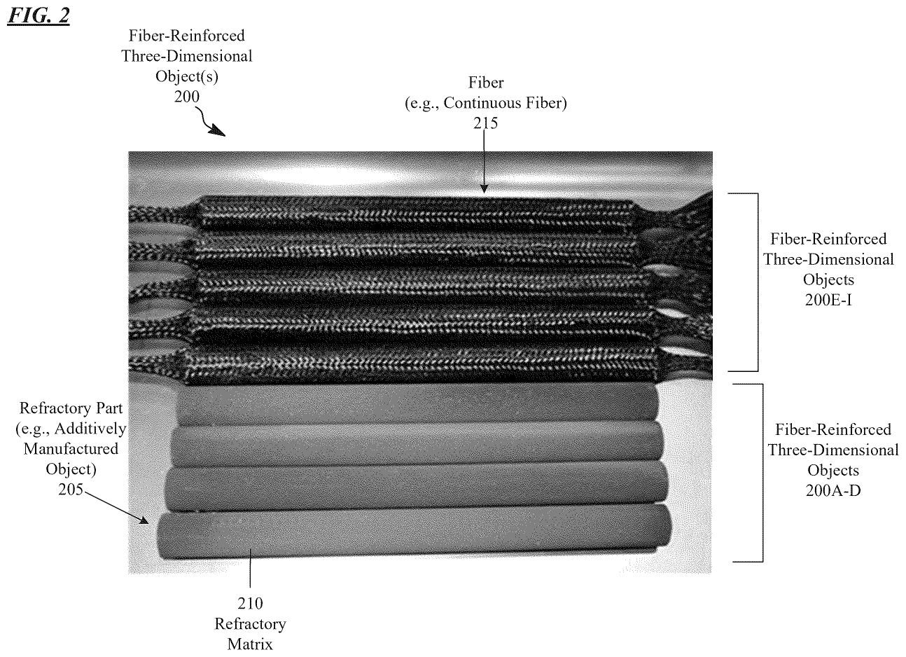

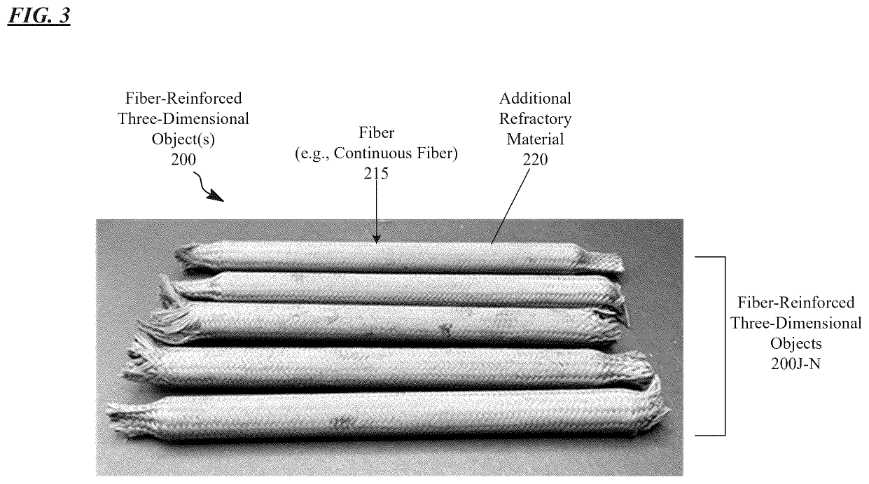

FIG. 1 is a flowchart of a fabrication method 100 for producing the fiber-reinforced three-dimensional object 200 shown in FIGS. 2-3. The fabrication method 100 can be for additive manufacturing of fiber-reinforced composites with refractory matrix materials. The fabrication method 100 can build on the previously described method for additive manufacturing of complex objects using refractory matrix materials (U.S. Pat. No. 11,285,635 B2 to Terrani, et al.).

Generally, the fabrication method 100 can start with additive manufacturing of a refractory part 205 (step 101). This step 101 may use binder jet additive manufacturing or any other methodology, such as laser powder bed fusion, stereolithography, laminated object manufacturing, direct ink printing or extrusion, gel casting, or a myriad of other methods.

Once the refractory part 205, such as an additively manufactured object 205, is produced, the additively manufactured object 205 can undergo treatments to strengthen it, increase its density, stress relieve it, etc. (step 101). The fabrication method 100 includes an additional set of steps 102, 103 for reinforcing the additively manufactured object 205 and structures with a continuous fiber 215. The steps of the fabrication method 100 are described in further detail below.

Beginning in step 101, the fabrication method 100 includes producing a refractory part 205. The step of producing the refractory part 205 can include: additive manufacturing (e.g., binder jet three-dimensional printing), laser powder bed fusion, stereolithography, laminated object manufacturing, direct ink printing or extrusion, gel casting, or a combination thereof.

As noted, the step 101 of producing the refractory part can include additive manufacturing of a refractory part 205. The step 101 of producing the refractory part 205 can include additive manufacturing the refractory part 205 via binder jet printing to form the refractory part 205 from a refractory material. For example, the step 101 of producing the refractory part 205 can include producing the refractory part 205 as an additively manufactured object 205 formed of the refractory material.

The step 101 of producing the refractory part 205 can further include performing a partial chemical vapor infiltration step to deposit additional refractory material 220 after additive manufacturing the refractory part 205. The refractory material can include silicon carbide (SiC). Once the refractory part 205 is produced, the refractory part 205 can undergo treatments for partial strengthening of the additively manufactured object 205, increasing density, stress relief, etc.

Moving to step 102, the fabrication method 100 further includes reinforcing the refractory part 205 with a fiber 215. The step 102 of reinforcing the refractory part 205 with the fiber 215 can include wrapping a braided fiber sleeve or a fiber sheet around the refractory part 205. The fiber 215 can include a continuous fiber 215. The step 102 of reinforcing the refractory part 205 with the fiber 215 can include wrapping, winding, pulling, placing, or incorporating the continuous fiber 215 in and around the additively manufactured object 205. The additively manufactured object 205 can include a refractory matrix 210 formed of the refractory material.

Continuous fiber 215 can be formed of a same type of refractory material as the refractory matrix 210. The refractory matrix 210 and the continuous fiber 215 can be formed of silicon carbide (SiC). The continuous fiber 215 can be wound around the additively manufactured object 205.

Alternatively, the continuous fiber 215 can be formed of a different type of refractory material than the refractory matrix 210. The refractory material can be formed of silicon carbide (SiC). The continuous fiber 215 can be formed of carbon (C).

The refractory part 205 can be an additively manufactured object 205 that includes a refractory matrix 210 formed of refractory material. The continuous fiber 215 can include a coating to act as an interphase between the continuous fiber 215 and the refractory matrix 210.

The fiber reinforcement of the additively manufactured object 205 in step 102 is carried out by wrapping, winding, pulling, placing, or incorporating the continuous fiber 215 in and around the additively manufactured object 205. The fiber 215 may be the same as the refractory material that forms the refractory matrix 205 (e.g., continuous SiC fiber wound around an SiC object) or dissimilar, (e.g., continuous C fiber wound around an SiC object). Note that this step 102 is distinct from prior art that incorporates chopped fiber or material whiskers into the part. The step 102 specifically targets continuous fiber 215 allowing for anisotropic tailoring of material properties and much more significant improvement in toughness and pseudo-ductility. The continuous fiber 215 may also contain a coating to act as an interphase between the fiber 215 and the refractory matrix 210. Once the continuous fiber 215 is incorporated into or around the additively manufactured object 205, the continuous fiber 215 may or may not be impregnated with the refractory matrix material prior to the next step 103.

Finishing in step 103, the fabrication method 100 further includes integrating the refractory part 205 and the fiber 215. The step 103 of integrating the refractory part 205 and the fiber 215 can include: depositing an additional refractory material 220 onto the additively manufactured object 205, into the additively manufactured object 205, or a combination thereof after reinforcing the refractory part 205 with the fiber 215. The step of depositing the additional refractory material 220 can include: chemical vapor infiltration/deposition, plasma spraying, slurry spraying, or dipping or glazing followed by sintering.

The step 103 involves mechanical integration of the additively manufactured object 205 and the continuous fiber 215. This may be achieved by a process that deposits the same refractory matrix material onto and/or into the additively manufactured object 205 that has been reinforced with continuous fiber 215. For example, the step 103 of integrating the refractory part 205 and the fiber 215 can include impregnating the continuous fiber 215 with additional refractory material 220 after wrapping, winding, pulling, placing, or incorporating the continuous fiber 215 in and around the additively manufactured object 205.

Integration of the refractory part 205 and the fiber 215 (step 103) can be achieved though methods, such as chemical vapor infiltration/deposition, plasma spray, slurry spraying or dipping or glazing followed by sintering, or other techniques. Hence, the step 103 of integrating the refractory part 205 and the fiber 215 can include subjecting the refractory part 205 and the fiber 215 to chemical vapor infiltration of additional refractory material 220.

The additional refractory material 220 can be a different type of refractory material than the refractory material that forms the refractory matrix 210. Alternatively, the additional refractory material 220 can be a same type of refractory material as the refractory material that forms the refractory matrix 210.

As described above, the fabrication method 100 can include in step 101 binder jet printing a complex refractory part 205 with an additive matrix 210 that includes SiC powder (step 101). The fabrication method 100 can further include in step 101 chemical vapor processing to deposit additional SiC into and onto the binder jet printed refractory part 205 to undergo partial densification to increase density and strength. The fabrication method 100 can further include in step 102 wrapping a fiber 215, such as braided carbon (C) fiber sleeves or sheets, around the refractory part 205. The fabrication method 100 can further include in step 103 subjecting the composite part (including the refractory part 205 with the wrapped fiber 215) to additional SiC CVI to produce an SiC/C composite in a complex geometry.

FIG. 2 illustrates the fiber-reinforced three-dimensional object 200 produced from the fabrication method 100 of FIG. 1 that includes a refractory part 205, such as an additively manufactured object 205, and a fiber 215. The additively manufactured object 205 includes a refractory matrix 210. The fiber 215 is depicted as a continuous fiber.

Depicted in FIG. 2 are examples of nine additively manufactured fiber-reinforced three-dimensional objects 200A-I produced via binder jet printing SiC and after partial strengthening (in this case via a partial CVI step). In FIG. 2, the example fiber-reinforced three-dimensional objects 200A-I are SiC bars with (top) and without (bottom) a fiber overwrap of carbon.

At the bottom of FIG. 2, four fiber-reinforced three-dimensional objects 200A-D are shown at the completion of step 101 of the fabrication method 100 and prior to step 102. The four fiber-reinforced three-dimensional objects 200A-D are shown after production of the refractory part 205, without the overwrap of fiber 215. In other words, the fiber 215 is removed from the four fiber-reinforced three-dimensional objects 200A-D shown at the bottom of FIG. 2.

The fiber-reinforced three-dimensional objects 200A-D can be binder jet printed and are shaped as rods in the example. The fiber-reinforced three-dimensional objects 200A-D can be any arbitrary shape, such as a polygonal shape (e.g., cuboid), spheroid, or other shapes that can include a planar surface, an aspherical surface, a spherical surface (e.g., cylinder, conical, quadric surfaces), a combination thereof, or a portion thereof (e.g. a truncated portion thereof). Alternatively or additionally, the fiber-reinforced three-dimensional objects 200A-D can include one more freeform surfaces that do not have rigid radial dimensions, unlike regular surfaces, such as a planar, aspherical, or spherical surface.

At the top of FIG. 2, the fiber-reinforced three-dimensional objects 200E-I include a fiber 215, such as silicon carbide (SiC). The fiber-reinforced three-dimensional objects 200E-I at the top of FIG. 2 are produced at the completion of the reinforcement step 102 of the fabrication method 100 and prior to step 103. The fiber-reinforced three-dimensional objects 200E-I include the refractory matrix 210, such as a partially-infiltrated silicon carbide (SiC) and an overwrap of the fiber 215. The overwrap of fiber 215 can be a carbon (C) fiber.

In an example, the fiber-reinforced three-dimensional object 200 includes an additively manufactured object 205 that includes a refractory matrix 210 formed of a refractory material. The fiber-reinforced three-dimensional object 200 further includes a continuous fiber 215 incorporated in and around the additively manufactured object 205.

The continuous fiber 215 can be formed of a same type of refractory material as the refractory matrix 210. The refractory matrix 210 and the continuous fiber 215 can be formed of silicon carbide (SiC). The continuous fiber 215 can be wound around the additively manufactured object 205.

Alternatively, the continuous fiber 215 can be formed of a different type of refractory material than the refractory matrix 210. The refractory material can be formed of silicon carbide (SiC). The continuous fiber 215 can be formed of carbon (C).

The continuous fiber 215 can be wrapped as a braided fiber sleeve or a fiber sheet around the refractory matrix 210. The refractory material can include silicon carbide (SiC), zirconium carbide (ZrC), graphite, carbon (C), or a combination thereof.

FIG. 3 illustrates the fiber-reinforced three-dimensional object 200 produced from the fabrication method 100 of FIG. 1 that further includes additional refractory material 220 after integration (step 103). Depicted in FIG. 3 are five example final products of fiber-reinforced three-dimensional objects 200J-N. The example fiber-reinforced three-dimensional objects 200J-N are a C fiber reinforced SiC matrix (C/SiC) composite in the form of simple rods. These rods are produced after a full CVI densification step 103 was applied to the parts (refractory part 205 and fiber 215) shown in FIG. 2.

In FIG. 3, five fiber-reinforced three-dimensional objects 200J-N are shown at the completion of step 103 of the fabrication method 100. The five fiber-reinforced three-dimensional objects 200J-N are shown after final densification (step 103), such as after CVI with SiC as the additional refractory material 220. The completed fiber-reinforced three-dimensional objects 200J-N are depicted as bar shaped, but can be any arbitrary shape.

The fabrication method 100 described herein can be used to produce components of a nuclear power plant in a terrestrial land application, e.g., for providing nuclear power (e.g., thermal and/or electrical power) for remote region applications, including outer space, celestial bodies, planetary bodies, and remotes regions on Earth. An example terrestrial land nuclear reactor system that the fiber-reinforced three-dimensional object 200 can be implemented in is described in FIG. 1A and the associated text of U.S. Pat. No. 11,264,141 to Ultra Safe Nuclear Corporation of Seattle, Washington, issued Mar. 1, 2022, titled “Composite Moderator for Nuclear Reactor Systems,” the entirety of which is incorporated by reference herein.

The fabrication method 100 described herein can be used to produce components of a nuclear reactor system utilized in a space environment, such as in a nuclear thermal propulsion (NTP) system. An example NTP system that the fiber-reinforced three-dimensional object 200 can be implemented in is described in FIGS. 1-2 and the associated text of U.S. Pat. No. 10,643,754 to Ultra Safe Nuclear Corporation of Seattle, Washington, issued May 5, 2020, titled “Passive Reactivity Control of Nuclear Thermal Propulsion Reactors” the entirety of which is incorporated by reference herein. In another example, the nuclear reactor system with the nuclear reactor core is utilized in a space reactor for electrical power production on a planetary surface.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best geometry and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A fabrication method, comprising steps of:
producing a refractory part;
reinforcing the refractory part with a fiber; and
integrating the refractory part and the fiber.

2. The fabrication method of claim 1, wherein the step of producing the refractory part includes:
additive manufacturing, laser powder bed fusion, stereolithography, laminated object manufacturing, direct ink printing or extrusion, gel casting, or a combination thereof.

3. The fabrication method of claim 1, wherein the step of producing the refractory part includes:
additive manufacturing the refractory part via binder jet printing to form the refractory part from a refractory material.

4. The fabrication method of claim 3, wherein the step of producing the refractory part further includes:
performing a partial chemical vapor infiltration step to deposit additional refractory material after additive manufacturing the refractory part.

5. The fabrication method of claim 3, wherein the refractory material includes silicon carbide (SiC).

6. The fabrication method of claim 1, wherein the step of reinforcing the refractory part with the fiber includes:
wrapping a braided fiber sleeve or a fiber sheet around the refractory part.

7. The fabrication method of claim 1, wherein the step of integrating the refractory part and the fiber includes:
subjecting the refractory part and the fiber to chemical vapor infiltration of additional refractory material.

8. The fabrication method of claim 1, wherein the fiber includes a continuous fiber.

9. The fabrication method of claim 8, wherein the step of producing the refractory part includes:
producing the refractory part as an additively manufactured object formed of a refractory material.

10. The fabrication method of claim 9, wherein the step of reinforcing the refractory part with the fiber includes:
wrapping, winding, pulling, placing, or incorporating the continuous fiber in and around the additively manufactured object.

11. The fabrication method for of claim 10, wherein:
the additively manufactured object includes a refractory matrix formed of the refractory material; and
the continuous fiber is formed of a same type of refractory material as the refractory matrix.

12. The fabrication method for of claim 11, wherein:
the refractory matrix and the continuous fiber are formed of silicon carbide (SiC); and
the continuous fiber is wound around the additively manufactured object.

13. The fabrication method of claim 10, wherein:
the additively manufactured object includes a refractory matrix formed of the refractory material; and
the continuous fiber is formed of a different type of refractory material than the refractory matrix.

14. The fabrication method of claim 13, wherein:
the refractory material is formed of silicon carbide (SiC); and
the continuous fiber is formed of carbon (C).

15. The fabrication method of claim 8, wherein:
the refractory part is an additively manufactured object that includes a refractory matrix formed of refractory material; and
the continuous fiber includes a coating to act as an interphase between the continuous fiber and the refractory matrix.

16. The fabrication method of claim 15, wherein the step of integrating the refractory part and the fiber includes:
impregnating the continuous fiber with additional refractory material after wrapping, winding, pulling, placing, or incorporating the continuous fiber in and around the additively manufactured object.

17. The fabrication method of claim 15, wherein the step of integrating the refractory part and the fiber includes:
depositing an additional refractory material onto the additively manufactured object, into the additively manufactured object, or a combination thereof after reinforcing the refractory part with the fiber.

18. The fabrication method of claim 17, wherein the step of depositing the additional refractory material includes:
chemical vapor infiltration/deposition, plasma spraying, slurry spraying, or dipping or glazing followed by sintering.

19. The fabrication method of claim 17, wherein the additional refractory material is a different type of refractory material than the refractory material that forms the refractory matrix.

20. The fabrication method of claim 17, wherein the additional refractory material is a same type of refractory material as the refractory material that forms the refractory matrix.

21. A fiber-reinforced three-dimensional object, comprising:
an additively manufactured object that includes a refractory matrix formed of a refractory material; and
a continuous fiber incorporated in and around the additively manufactured object.

22. The fiber-reinforced three-dimensional object of claim 21, wherein:
the continuous fiber is formed of a same type of refractory material as the refractory matrix.

23. The fiber-reinforced three-dimensional object of claim 22, wherein:
the refractory matrix and the continuous fiber are formed of silicon carbide (SiC); and
the continuous fiber is wound around the additively manufactured object.

24. The fiber-reinforced three-dimensional object of claim 21, wherein:
the continuous fiber is formed of a different type of refractory material than the refractory matrix.

25. The fiber-reinforced three-dimensional object of claim 24, wherein:
the refractory material is formed of silicon carbide (SiC); and
the continuous fiber is formed of carbon (C).

26. The fiber-reinforced three-dimensional object of claim 21, wherein:
the continuous fiber is wrapped as a braided fiber sleeve or a fiber sheet around the refractory matrix.

27. The fiber-reinforced three-dimensional object of claim 21, wherein:
the refractory material includes silicon carbide (SiC), zirconium carbide (ZrC), graphite, carbon (C), or a combination thereof.
